(19) United States
(12) Patent Application Publication
(10) Pub. No.: US 2008/0301389 A1
(43) Pub. Date: Dec. 4, 2008

(54) MEMORY-PROTECTION METHOD AND APPARATUS

(75) Inventors: Hyo-Jun KIM, Yongin-si (KR); Song-Ho YOON, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/125,954

(22) Filed: May 23, 2008

(30) Foreign Application Priority Data
May 28, 2007 (KR) 10-2007-0051568

(51) Int. Cl. G06F 12/14; G06F 9/46

(52) U.S. Cl. 711/163; 718/100; 718/104; 711/E12.091

(57) ABSTRACT

A memory-protection method and apparatus is provided that can protect a memory that is used by components in a real time operating system environment (RTOS). The memory-protection method includes requesting access to a first memory region that a first component uses when the first component is called to execute a first task in a real time operating system, and permitting the first task to access the first memory region with reference to a task list that includes information on tasks which are permitted to access the first memory region.

### CROSS-REFERENCE TO RELATED APPLICATION

This application claims priority from Korean Patent Application No. 10-2007-0051568 filed on May 28, 2007 in the Korean Intellectual Property Office, the disclosure of which is incorporated herein in its entirety by reference.

### BACKGROUND OF THE INVENTION

1. Field of the Invention

Method and apparatuses consistent with the present invention relate to memory protection method and apparatus, and, more particularly, to protection of a memory that is used by components in a real time operating system environment.

2. Description of the Related Art

Generally, operating systems provide functions that protect memory from user processes. In order to provide this protection, the operating system, as shown in FIG. 1, divides a memory region into a kernel region and a user region, and if a new process is executed by context switching, the operating system performs mapping of the process being executed onto the user region so as to inhibit the user process from accessing the memory used by the operating system. In order words, the memory-protection technique permits a user process to access only a user region allocated to the process, and inhibits the user process from accessing memory spaces of other processes or a memory space that is used by the kernel. This protection function prevents unreliable user processes from stopping the whole system or other processes.

However, since the related art memory-protection technique is to protect an operating system, i.e., the system, from user processes, this technique cannot protect a memory from the viewpoint of a component such as a file system, a library, and so forth. That is, in the related art technique, the component is made in the form of a kernel driver and is included in the operating system as a part of the operating system. According to this technique, the memory that components use can be protected from user processes, but the memory cannot be protected from other kernel drivers. Accordingly, in the case where an external code invades the memory that is used by a component, a developer may mistakenly conclude that the component is malfunctioning because of a bug in the component. Consequently, the development, repair, and maintenance of the component is very difficult.

In addition, the related art memory-protection technique can be used only in a general operating system that uses a process model. However, the related protection art technique is difficult to apply to a real time operating system (RTOS) in which all tasks share the memory space. For example, as shown in FIG. 2, when a specified component is called during execution of a first task, the first task can access the memory region that the called component uses. If a second task is executed by context switching before the execution of the first task is completed, the second task can also access the memory region. In this case, it is probable that the memory region will be corrupted by the second task.

### SUMMARY OF THE INVENTION

The present invention provides a memory-protection method and apparatus that can protect a memory that components use in a real time operating system environment.

According to an aspect of the present invention, there is provided a memory-protection method that includes requesting access to a first memory region that a first component uses when the first component is called to execute a first task in a real time operating system; and permitting the first task to access the first memory region with reference to a task list that includes information on tasks having access to the first memory region.

According to another aspect of the present invention, there is provided a memory-protection apparatus, which includes a request unit requesting access to a first memory region that a first component uses when the first component is called to execute a first task in a real time operating system; and a memory-access controller permitting the first task to access the first memory region with reference to a task list that includes information on tasks of which the access to the first memory region is permitted.

### BRIEF DESCRIPTION OF THE DRAWINGS

The above and other aspects of the present invention will become apparent from the following detailed description of exemplary embodiments taken in conjunction with the accompanying drawings, in which:

FIG. 1 is a view explaining a related art memory-protection technique;

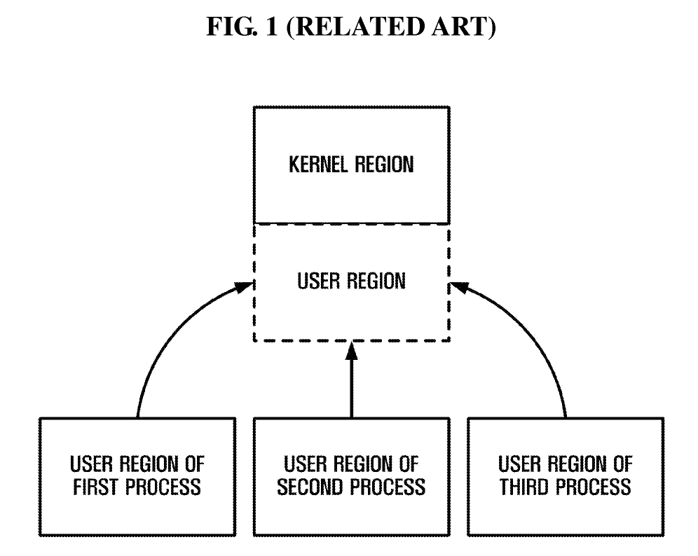

FIG. 2 is a view explaining problems that may occur due to a context switching in an RTOS environment;

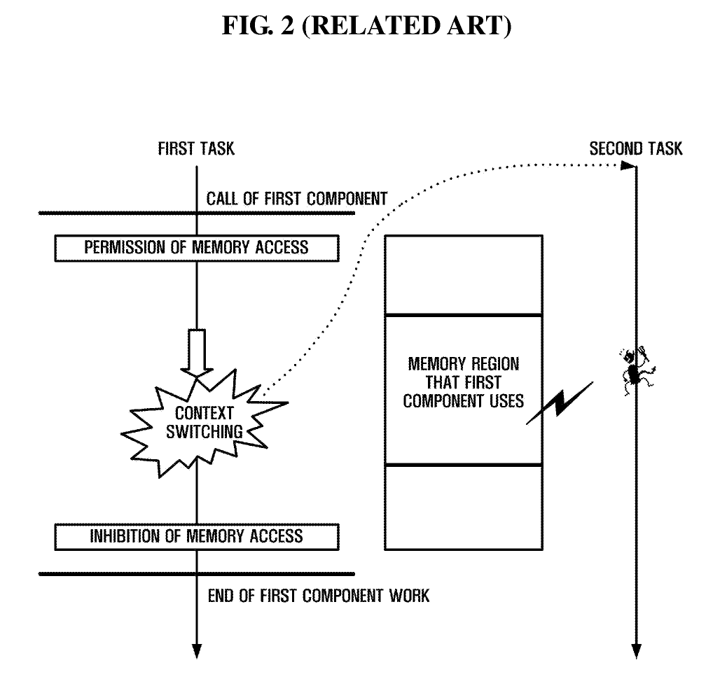

FIG. 3 is a view illustrating the construction of a memory-protection apparatus according to an exemplary embodiment of the present invention;

FIG. 4 is a view explaining a task list according to an exemplary embodiment of the present invention;

FIG. 5 is a flowchart illustrating an operation process of a memory-protection apparatus according to an exemplary embodiment of the present invention;

FIG. 6 is a flowchart illustrating in detail permitting access to the memory region S520 of FIG. 5;

FIG. 7 is a flowchart illustrating in detail inhibiting access to the memory region S580 of FIG. 5;

FIG. 8 is a view illustrating the construction of a memory-protection apparatus according to another exemplary embodiment of the present invention;

FIG. 9 is a flowchart illustrating an operation of a memory-protection apparatus according to another exemplary embodiment of the present invention; and

FIG. 10 is a flowchart illustrating in detail processing the page fault S960 of FIG. 9.

### DETAILED DESCRIPTION OF EXEMPLARY EMBODIMENTS OF THE INVENTION

Hereinafter, exemplary embodiments of the present invention will be described in detail with reference to the accompanying drawings. The aspects and features of the present invention and methods for achieving the aspects and features will become apparent by referring to the exemplary embodiments to be described in detail with reference to the accompanying drawings. However, the present invention is not limited to the embodiments disclosed hereinafter, but can be implemented in diverse forms. The matters defined in the description, such as the detailed construction and elements, are nothing but specific details provided to assist those of ordinary skill in the art in a comprehensive understanding of the invention, and the present invention is only defined within the scope of the appended claims. In the entire description of the present invention, the same drawing reference numerals are used for the same elements across various figures.

The present invention will be described herein with reference to the accompanying drawings illustrating block diagrams and flowcharts for explaining a memory-protection method and apparatus according to exemplary embodiments of the present invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded into a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Also, each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

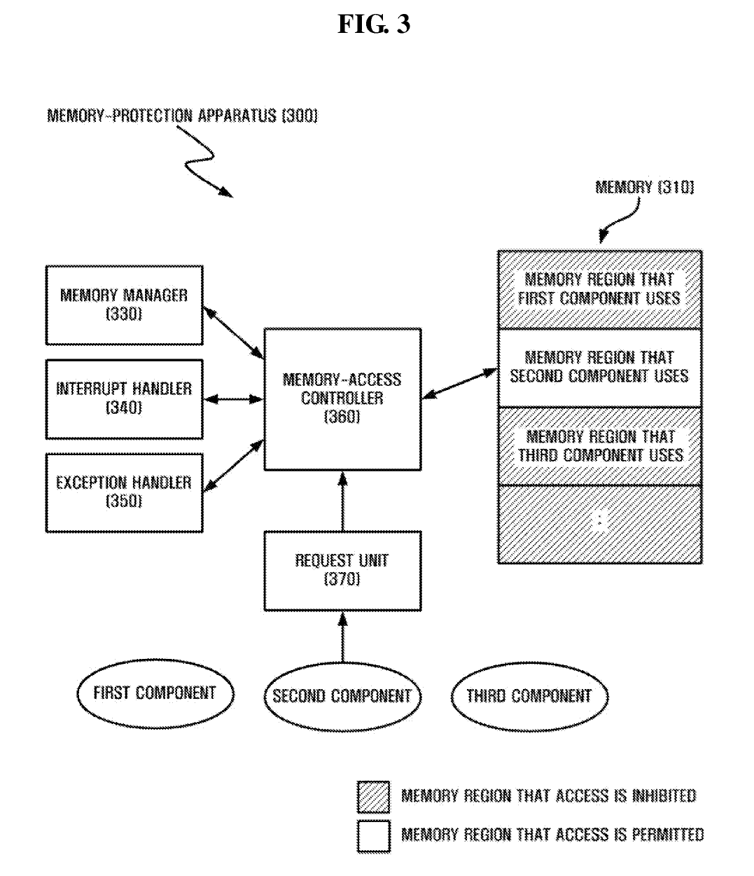

FIG. 3 is a view illustrating the construction of a memory-protection apparatus according to an exemplary embodiment of the present invention. As illustrated in FIG. 3, a memory-protection apparatus 300 according to an exemplary embodiment of the present invention includes a memory 310, a memory manager 330, a request unit 370, a memory-access controller 360, an interrupt handler 340, and an exception handler 350.

An address space of the memory 310 may be divided into specified units, for example, in the units of a page. The page is a kind of mapping unit, and may have a size of 4 K or 64 K. The address space divided in the unit of a page is allocated for each component.

The memory manager 330 converts virtual addresses of a memory region that components use into physical addresses. In order to achieve this conversion, the memory manager 330 refers to a page table (not illustrated) that indicates corresponding relationships between the virtual addresses of the memory region that the components use and the physical addresses. Further, in order to create the page table, the memory manager 330 divides the address space of the memory pages, and allocates the divided address space for each component. The page table includes information on an authority to access the memory region that the components use, and the page table is initialized so as to make it impossible to access the entire memory region.

When a component is called to execute a task, the request unit 370 requests the memory-access controller 360 to permit an access to the memory region that used by the called component. If the execution of the called component is completed, the request unit 370 requests the memory-access controller 360 to inhibit the access to the memory region that the called component uses. Although in FIG. 3, it is exemplified that the request unit 370 is separated from the components, the request unit may be implemented as a part of the respective components. In this case, the permission/inhibition of access to the memory region that a specified component uses is requested by the corresponding component.

The memory-access controller 360 controls the access to the memory region that is requested by the request unit 370. For example, when the request unit 370 requests to permit access to the memory region used by a specified component, the memory-access controller 360 controls the memory manager 330 to permit the access to the memory region used by the corresponding component. If the request unit 370 requests to inhibit access to the memory region used by the specified component, the memory-access controller 360 controls the memory manager 330 to inhibit access to the memory region used by the corresponding component.

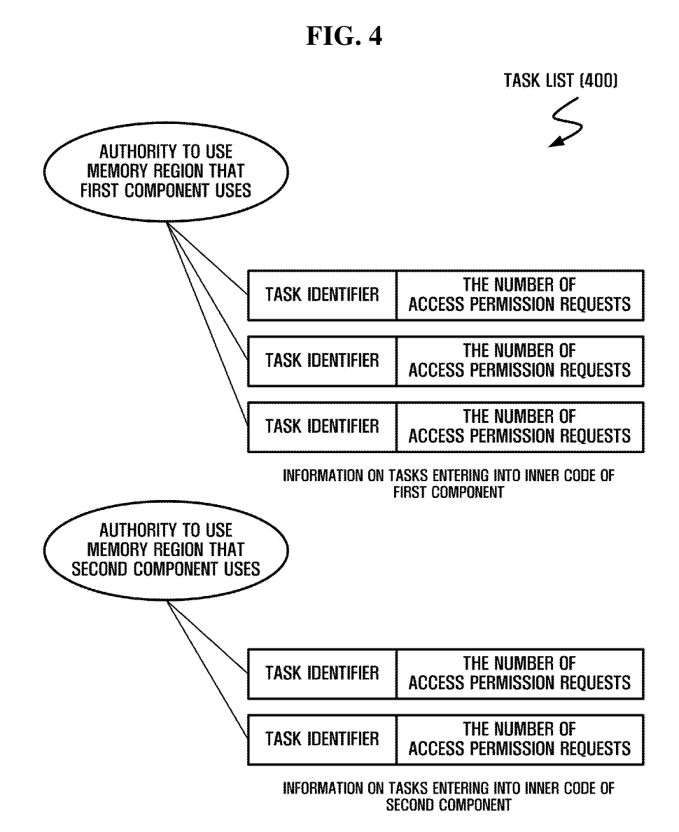

In addition, the memory-access controller manages a task list 400. The task list 400 includes information on tasks which are permitted to access the memory region used by the components, i.e., information on tasks having the authority to access the memory region. Here, the task information includes at least one of an identifier of a task and the number of times the corresponding task requests permission to access the same memory region (hereinafter referred to as “the number of times the access permission is requested”). As shown in FIG. 4, the task list 400 is divided by components.

Referring to FIG. 3, if a request for permission/inhibition of access to a specified memory region is received from the request unit 370, the memory-access controller 360 controls the requested access to the memory region, with reference to the task list 400 as illustrated in FIG. 4.

For example, if the first task calls the first component, the memory-access controller 360 judges whether the first task already has an authority to access the first memory region used by the first component, with reference to the task list 400.

If the first task has the authority to access the first memory region as a result of the judgment, the memory-access controller 360 increases the number of times the first task requests the access in the task list 400.

By contrast, if the first task has no authority to access the first memory region, the memory-access controller 360 controls the memory manager 330 to permit the access to the first memory region. Thereafter, the memory-access controller 360 inserts information on the first task into the task list 400. At this time, the number of times the first task requests the access permission is set to “1”.

However, if the first component completes its work and receives a request for inhibition of access to the first memory region, the memory-access controller 360 judges whether the request for access inhibition is proper. To decide whether the access inhibition is proper, the memory-access controller 360 searches for the identifier of the first task in the task list 400.

Specifically, if the first task does not exist among the tasks having the authority to access the first memory region as a result of searching the test list 400, it is judged that the first task has no authority to access the first memory region. Accordingly, the memory-access controller 360 judges the request for inhibition of access to the first memory regions to be abnormal, and thus generates an error.

If the first task exists among the tasks having the authority to access the first memory region as a result of searching the test list 400, it is judged that the first task already has the authority to access the first memory region. In this case, the memory-access controller 360 decreases the number of times the first task requests the access permission in the task list 400. If the number of times the first task requests access becomes “0”, the memory-access controller 360 controls the memory manager 330 to inhibit the first task from accessing the first memory region, and then deletes the information on the first task from the task list 400.

Accordingly, when a second task is executed by context switching in a state that the first task is permitted to access the first memory region, it can be confirmed with reference to the task list 400 whether the second task has an authority to access the first memory region, and thus the first memory region can be protected from the second task.

The interrupt handler 340 handles a software interrupt or a hardware interrupt.

The exception handler 350 handles an exception such as an interrupt, an abort, or an undefined instruction when it occurs. For example, an abort exception may occur when it is impossible to access the memory region in which a required instruction or data is stored.

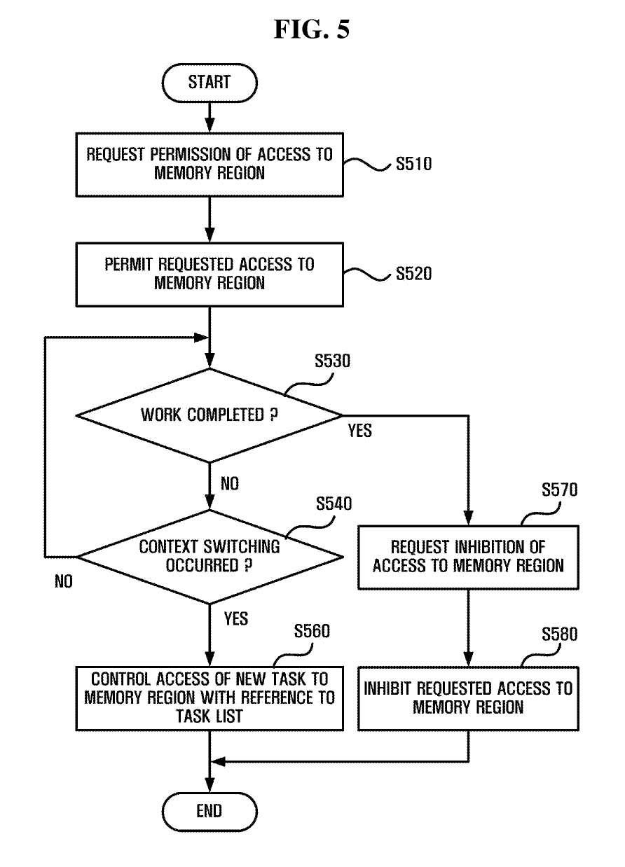

FIG. 5 is a flowchart illustrating an operation process of a memory-protection apparatus 300 according to an embodiment of the present invention.

If a first component is called to perform a first task, the request unit 370 requests the memory-access controller 360 to permit an access to a memory region (hereinafter referred to as a “first memory region”) that the first component uses (S510).

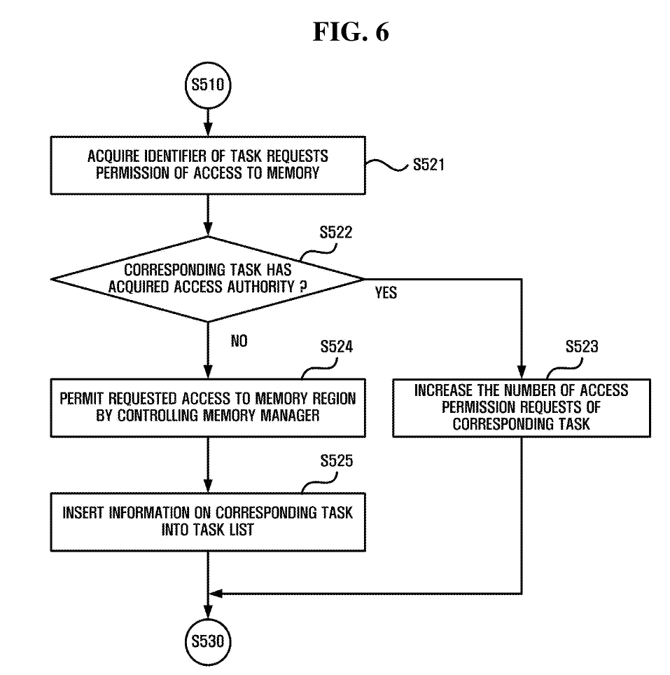

The memory-access controller 360 permits the access to the first memory region if the request for access permission is proper (S520). In S520, the memory-access controller 360 refers to the task list 400 that includes information on tasks having the authority to access the first memory region to judge whether the request for access permission is proper. Permission of access to the memory region (S520) will be further described in more detail with reference to FIG. 6.

When the first task is completed after the first task acquires the authority to access the first memory region (“Yes” in S530), the request unit 370 requests the memory-access controller 360 to inhibit the access to the first memory region (S570).

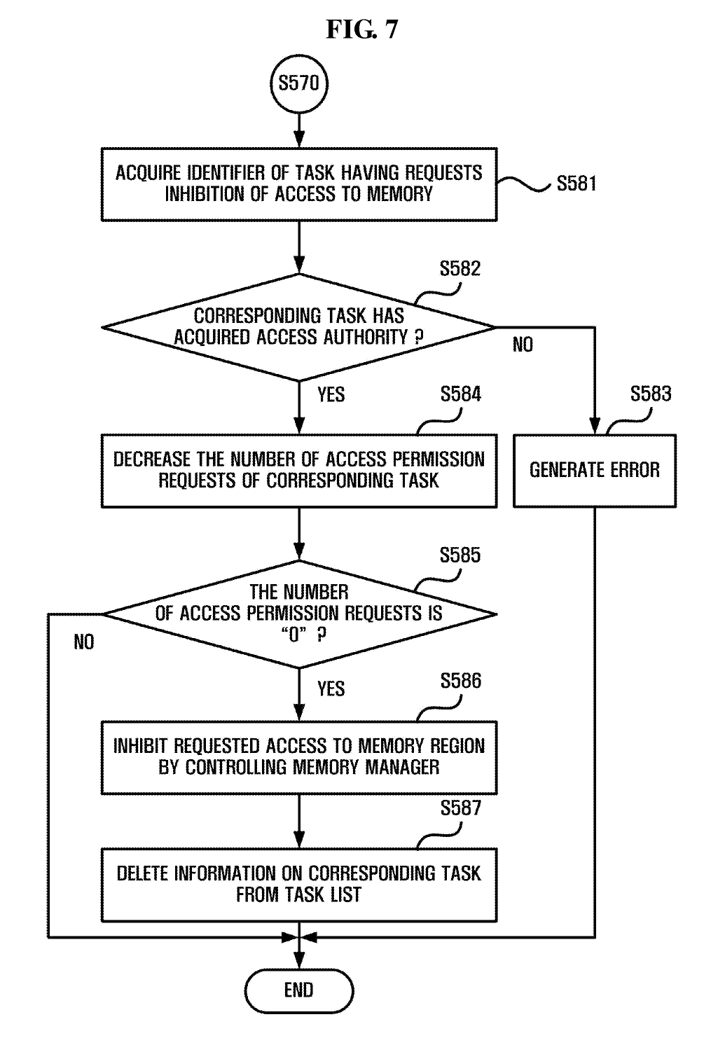

If the request for inhibition of access to the first memory region received from the request unit 370 is proper, the memory-access controller 360 inhibits the access to the first memory region (S580). At this time, in order to judge whether the request for access inhibition is proper, the memory-access controller 360 refers to the task list 400 that includes information on the tasks having the authority to access the first memory region. Inhibition of access to the memory region (S580) will be further described in more detail with reference to FIG. 7.

By contrast, if a new task (hereinafter referred to as a “second task”) is executed due to the occurrence of context switching in a state that the first task has the authority to access the first memory region (i.e., in a state that the access to the first memory region is permitted to the first task; “Yes” in S540), the memory-access controller 360 controls the access of the second task to the first memory region with reference to the pre-stored task list 400 (S560).

FIG. 6 is a flowchart illustrating in detail the steps of permitting an access to the memory region (S520) in FIG. 5.

First, the memory-access controller 360 acquires the identifier of the first task S521.

Then, the memory-access controller 360 searches for the identifier of the first task in the task list 400, and judges whether the first task already acquires the authority to access the first memory region (S522).

Specifically, if the identifier of the first task exists among the tasks having acquired the authority to access the first memory region as a result of searching the task list 400, the memory-access controller 360 judges that the first task has acquired the authority to access the first memory region (“Yes” in S522). In other words, the memory-access controller 360 judges that the access of the first task to the first memory region has already been permitted. In this case, the memory-access controller 360 increases the number of times the first task requests the access permission by “1” in the task list 400 (S523).

If the identifier of the first task does not exist among the tasks having acquired the authority to access the first memory region as a result of searching the task list 400, the memory-access controller 360 judges that the first task has not yet acquired the authority to access the first memory region (“No” in S522). In other words, the memory-access controller 360 judges that the access of the first task to the first memory region has not yet been permitted. In this case, the memory-access controller 360 controls the memory manager 330 to give the authority to access the first memory region to the first task (S524).

If the first task acquires authority to access the first memory region, the memory-access controller 360 inserts information on the first task, i.e., the identifier of the first task and the number of times the first task requests the access permission, into the task list (S525). As a result, the number of times the first task requests the access permission is set to “1”.

FIG. 7 is a flowchart illustrating in detail inhibiting access to the memory region (S580) in FIG. 5.

When the request for inhibition of access to the first memory regions is received, the memory-access controller 360 first acquires the identifier of the first task (S581).

Then, the memory-access controller 360 judges whether the first task has acquired the authority to access the first memory region by searching for the identifier of the first task in the task list 400 (S582).

Specifically, if the identifier of the first task does not exist among the tasks having the authority to access the first memory region as a result of searching the task list 400, the memory-access controller 360 judges that the first task has not acquired the authority to access the first memory region (“No” in S582). In this case, the memory-access controller 360 judges that the request for access inhibition is not proper, and generates an error (S583).

If the identifier of the first task exists among the tasks having the authority to access the first memory region as a result of searching the task list 400, the memory-access controller 360 judges that the first task has acquired the authority to access the first memory region (“Yes” in S582). In this case, the memory-access controller 360 judges that the request for access inhibition is proper, and decreases the number of times the first task requests the access permission by “1” in the task list 400 (S584).

If the decreased number of times the first task requests the access permission equals “0” (“Yes” in S585), the memory-access controller 360 controls the memory manager 330 to inhibit the first task from accessing the first memory region (S586).

Then, the memory-access controller 360 deletes the information on the first task, i.e., delete the identifier of the first task from the task list 400 (S587).

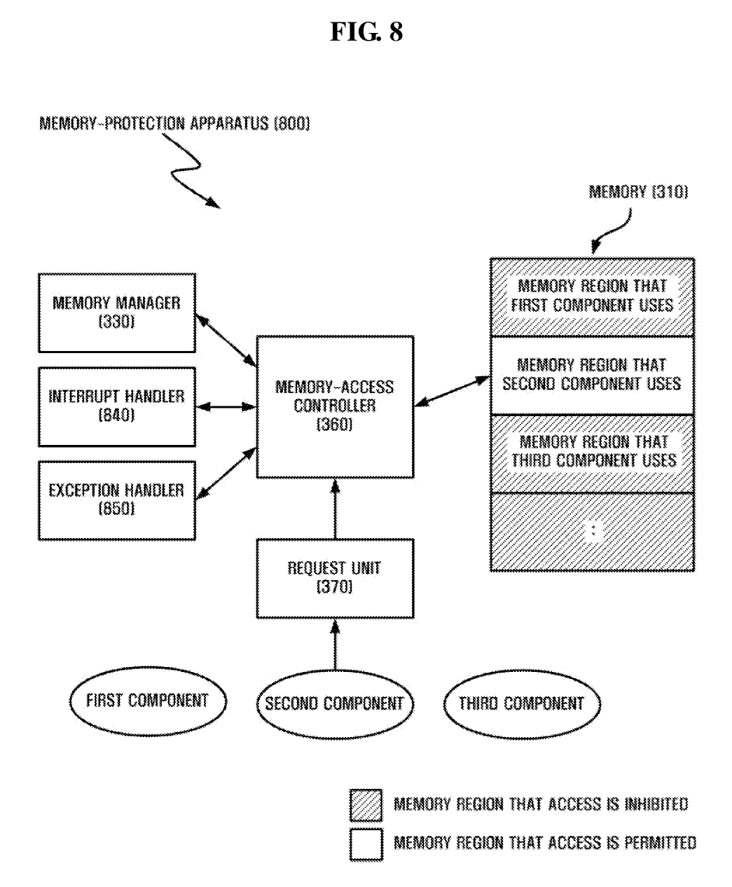

FIG. 8 is a view illustrating the construction of a memory-protection apparatus 800 according to another exemplary embodiment of the present invention. As illustrated in FIG. 8, a memory-protection apparatus 800 according to another embodiment of the present invention includes a memory 310, a memory manager 330, a request unit 370, a memory-access controller 360, an interrupt handler 840, and an exception handler 850.

Since the memory 310, the memory manager 330, the request unit 370, and the memory-access controller 360 as illustrated in FIG. 8 are the same as those according to the first exemplary embodiment of the present invention described above. Therefore, a duplicate explanation has been omitted, and the explanation will center on the interrupt handler 840 and the exception handler 850.

If an exception such as an interrupt, an abort, or an undefined instruction occurs, the interrupt handler 840 inhibits the access to the memory region that all the components use before handling the exception.

If a certain task attempts to access a certain memory region in a state that an access to the memory region that all the component use is inhibited, a page fault may be generated with respect to the memory region that the task intends to access. If a page fault is generated, the exception handler 850 judges whether the access of the task to the memory region is proper, and then handles the page fault.

For a detailed explanation, it is exemplified that the first task attempts to access the first memory region that the first component uses.

If the first task attempts to access the first memory region in a state that the access to the memory region that all the component use is inhibited, a page fault is generated with respect to the first memory region.

When a page fault is generated, the exception handler 850 confirms the component that uses the memory region to which the address that has generated the page fault belongs, with reference to a page table.

Then, the exception handler 850 acquires the identifier of the task currently executing, i.e., the first task.

Then, the exception handler 850 judges whether the access of the first task to the memory is proper. In order to achieve this judgment function, the exception handler 850 searches for the identifier of the first task in the task list 400 (see FIG. 4).

Specifically, if the first task does not exist among the tasks having the authority to access the first memory region as a result of searching the task list, it is judged that the access of the first task to the memory is improper. In this case, the memory-access controller 360 generates an error to report that the access of the first task to the memory is improper.

If the first task exists among the tasks having the authority to access the first memory region as a result of searching the task list, it is judged that the access of the first task to the memory is proper. In this case, the memory-access controller 360 controls the memory manager 330 to permit the first task to access the first memory region.

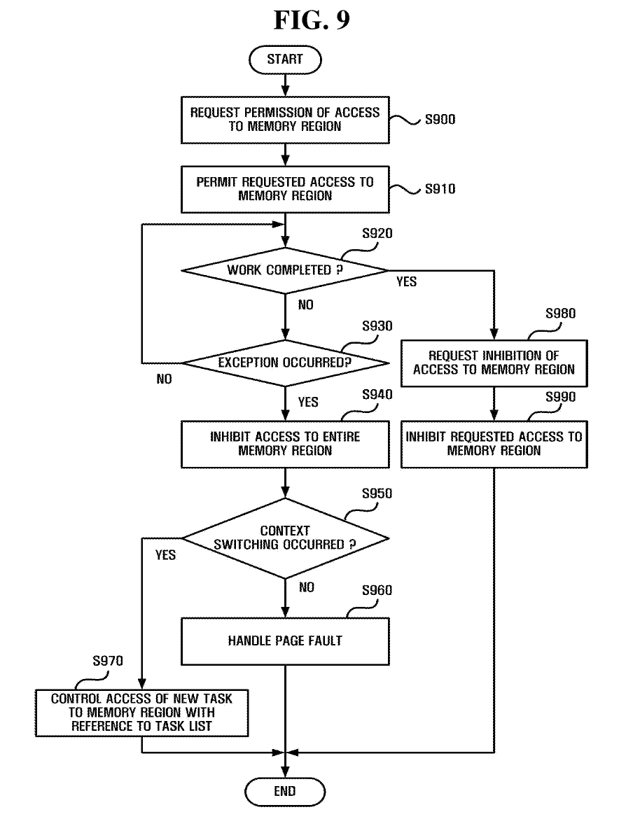

FIG. 9 is a flowchart illustrating an operation process of a memory-protection apparatus 800 according to another exemplary embodiment of the present invention.

If a first component is called to perform a first task, the request unit 870 requests the memory-access controller 860 to permit an access to a memory region (hereinafter referred to as a “first memory region”) that the first component uses (S900).

The memory-access controller 860 permits the access to the first memory region if the request for access permission is proper (S910). In this step, the memory-access controller 860 refers to the task list that includes information on tasks having the authority to access the first memory region to judge whether the request for access permission is proper. Permission of access to the memory region (S910) is as described above with reference to FIG. 6, the explanation thereof has been omitted.

When the first task is completed after the first task acquires the authority to access the first memory region, the request unit 370 requests the memory-access controller 360 to inhibit the access to the first memory region (S980).

If the request for inhibition of access to the first memory region received from the request unit is proper, the memory-access controller 360 inhibits the access to the first memory region (S990). In order to judge whether the request for access inhibition is proper, the memory-access controller 860 refers to the task list that includes information on the tasks having the authority to access the first memory region. Inhibition of access to the memory region (S890) is as described above with reference to FIG. 7, and the explanation thereof has been omitted.

By contrast, if an exception occurs due to an interrupt, an abort, or an undefined instruction in a state that the first task has the authority to access the first memory region (i.e., in a state that the access of the first task to the first memory region is permitted; “Yes” in S930), the interrupt handler 840 inhibits the access to the memory region that all the components use (S940).

Then, if a new task (hereinafter referred to as a “second task”) is executed due to the occurrence of context switching in a state where the access to the memory region that all the components use is inhibited (“Yes” in S950), the memory-access controller 360 controls the access of the second task to the first memory region with reference to the pre-stored task list (S970).

Specifically, if the second task exists as a result of searching the tasks having the authority to access the first memory region in the task list, the memory-access controller 360 increases the number of times the second task requests the access permission in the task list.

If the second task does not exist as a result of searching the tasks having the authority to access the first memory region in the task list, the memory-access controller 860 controls the memory manager 830 to permit the second task to access the first memory region. Then, the memory-access controller inserts the information on the second task into the task list. At this time, the number of times the second task requests the access permission may be set to “1”.

In contrast, if no context switching occurs (“No” in S950), the first task is continuously executed. However, if the first task attempts to access the first memory region in a state where access to the memory region used by all of the component is inhibited, a page fault is generated in the first memory region.

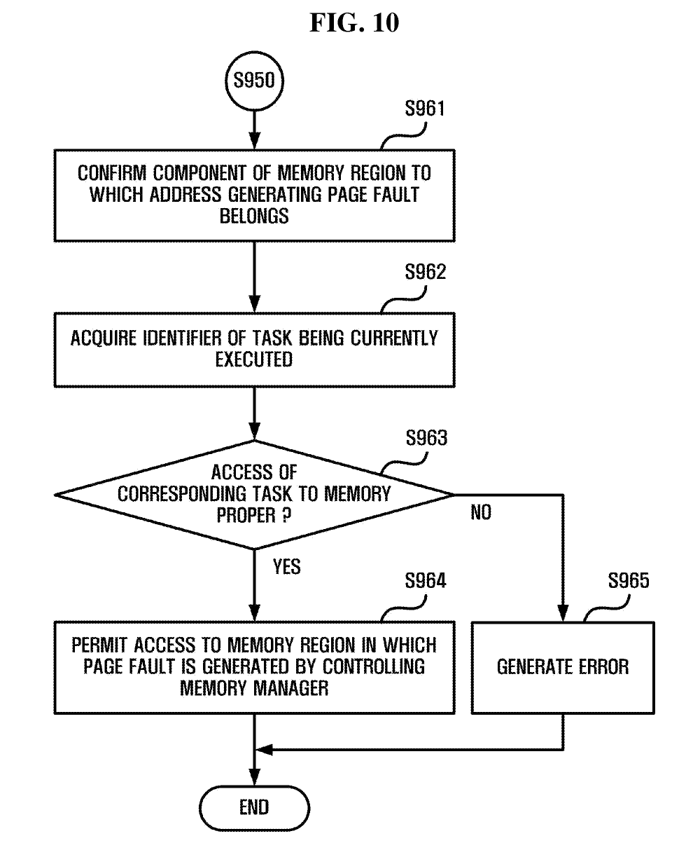

When the page fault is generated, the exception handler 850 judges whether the access of the first task to the memory is proper, and then handles the page fault according to the result of judgment (S960). The page-fault handling (S960) will be described in more detail with reference to FIG. 10.

First, the exception handler 850 confirms the component that uses the memory region to which an address that has generated the page fault belongs, with reference to a page table (S961).

Then, the exception handler 850 acquires the identifier of the first task being currently executed (S962), and judges whether the access of the first task to the memory is proper. For this, the exception handler 850 searches for the identifier of the first task in the task list.

Specifically, if the first task does not exist among the tasks having the authority to access the first memory region as a result of searching the task list, the exception handler 850 judges that the access of the first task to the memory is improper (“No” in S963). In this case, the memory-access controller 360 generates an error to report that the access of the first task to the memory is improper (S965).

If the first task exists among the tasks having the authority to access the first memory region as a result of searching the task list, the exception handler 850 judges that the access of the first task to the memory is proper (“Yes” in S963). In this case, the memory-access controller 360 controls the memory manager 330 to give the authority to access the first memory region to the first task (S964).

As described above, the memory-protection method and apparatus according to exemplary embodiments of the present invention may produce the following effects.

A memory that components use in a real time operating system can be protected from other components or external code.

A system malfunction due to a wrong memory access can be easily found and corrected, and thus the development time of the system can be shortened with the stability of the system improved.

Although the memory-protection method and apparatus according to the exemplary embodiments of the present invention has been described for illustrative purposes, those skilled in the art will appreciate that various modifications, additions and substitutions are possible, without departing from the scope and spirit of the invention. The foregoing embodiments are merely exemplary and are not to be construed as limiting the present invention. Therefore, the scope of the present invention should be defined by the appended claims and their legal equivalents.

What is claimed is:

1. A memory-protection method comprising:
requesting access to a first memory region that a first component uses if the first component is called to execute a first task in a real time operating system; and
permitting the first task to access the first memory region with reference to a task list that includes information on tasks which are permitted to access the first memory region.

2. The memory-protection method of claim 1, further comprising creating a page table that indicates corresponding relations of virtual addresses of the first memory region to physical addresses.

3. The memory-protection method of claim 2, wherein the creating the page table further comprises:
grouping memory address spaces in a specified unit;
allocating the grouped address spaces to components; and
storing corresponding relations of the allocated address spaces to the components.

4. The memory-protection method of claim 3, wherein the specified unit is a page composed of one address space or a plurality of successive address spaces.

5. The memory-protection method of claim 3, further comprising initializing the page table so as to inhibit access to the grouped address spaces.

6. The memory-protection method of claim 1, further comprising storing information on the first task to which access is permitted in the task list;
wherein the information includes at least one of an identifier of the first task and a number of times the first task requests permission to access the first memory region.

7. The memory-protection method of claim 6, wherein the storing the information on the first task in the task list comprises adding the information on the first task to the task list if the access of the first task to the first memory region is not permitted.

8. The memory-protection method of claim 6, wherein the storing the information on the first task comprises increasing the number of times the first task requests the access permission if the access of the first task to the first memory region has already been permitted.

9. The memory-protection method of claim 6, further comprising:
requesting inhibition of access to the first memory region if the first task of which the access is permitted is completed; and
inhibiting the access to the first memory region.

10. The memory-protection method of claim 9, wherein the inhibiting the access to the first memory region comprises:
decreasing the number of times the first task requests the access permission; and
if the decreased number of times the first task requests the access permission is “0”, deleting the information on the first task from the task list.

11. The memory-protection method of claim 1, further comprising:
if a second task calls the first component in a state that the first task has called the first component, searching for information on the second task in the task list; and
if the information on the second task exists in the task list, permitting the second task to access the first memory region.

12. The memory-protection method of claim 11, further comprising: if the information on the second task does not exist in the task list, generating an error.

13. The memory-protection method of claim 1, further comprising if an interrupt is generated in a state that the first task has called the first component, inhibiting the access to the entire memory region.

14. The memory-protection method of claim 13, further comprising:
if the first task accesses the first memory region after the interrupt is generated, generating a page fault;
searching for the information on the first task in the task list; and
if the information on the first task exists in the task list, permitting the first task to access the first memory region.

15. The memory-protection method of claim 14, further comprising generating an error if the information on the first task does not exist in the task list.

16. A memory-protection apparatus comprising:
a request unit which requests access to a first memory region that a first component uses when the first component is called to execute a first task in a real time operating system; and
a memory-access controller which permits the first task to access the first memory region with reference to a task list that includes information on tasks of which the access to the first memory region is permitted.

17. The memory-protection apparatus of claim 16, further comprising a memory manager which creates a page table that indicates corresponding relations of virtual addresses of the first memory region to physical addresses.

18. The memory-protection apparatus of claim 17, wherein the memory manager groups memory address spaces in a specified unit, allocates a grouped address spaces to components, and stores corresponding relations of the allocated address spaces to the components.

19. The memory-protection apparatus of claim 18, wherein the unit is a page composed of one address space or a plurality of successive address spaces.

20. The memory-protection apparatus of claim 18, wherein the memory manager initializes the page table so as to inhibit an access to the grouped address spaces.

21. The memory-protection apparatus of claim 16, wherein the memory-access controller stores information on the first task of which the access is permitted in the task list, and the information includes at least one of an identifier of the first task and a number of times the first task requests permission to access the first memory region.

22. The memory-protection apparatus of claim 21, wherein the memory-access controller adds the information on the first task to the task list if the access of the first task to the first memory region is not permitted.

23. The memory-protection apparatus of claim 21, wherein the memory-access controller increases the number of times the first task requests the access permission if the access of the first task to the first memory region has already been permitted.

24. The memory-protection apparatus of claim 21, wherein the memory-access controller inhibits the access to the first memory region if the first task of which the access is permitted is completed and thus a request for inhibition of access to the first memory region is requested.

25. The memory-protection apparatus of claim 24, wherein the memory-access controller decreases the number of times the first task requests the access permission, and if the decreased number of times the first task requests the access permission is “0”, it deletes the information on the first task from the task list.

26. The memory-protection apparatus of claim 16, wherein the memory-access controller searches for information on the second task in the task list if a second task calls the first component in a state that the first task has called the first component, and permits the second task to access the first memory region if the information on the second task exists in the task list.

27. The memory-protection apparatus of claim 26, wherein the memory-access controller generates an error if the information on the second task does not exist in the task list.

28. The memory-protection apparatus of claim 16, further comprising an interrupt handler inhibiting access to the entire memory region if an interrupt is generated in a state where the first task has called the first component.

29. The memory-protection apparatus of claim 28, further comprising an exception handler searching for the information on the first task in the task list if the first task accesses the first memory region after the interrupt is generated and thus a page fault is generated, and permitting the first task to access the first memory region if the information on the first task exists in the task list as a result of searching.

30. The memory-protection apparatus of claim 29, wherein the exception handler generates an error if the information on the first task does not exist in the task list.
